(19) United States
(12) Patent Application Publication
(10) Pub. No.: US 2024/0419639 A1
(43) Pub. Date: Dec. 19, 2024

(54) JOURNAL STORAGE ACCELERATION METHOD AND APPARATUS, ELECTRONIC DEVICE AND NON-VOLATILE READABLE STORAGE MEDIUM

(71) Applicant: SUZHOU METABRAIN INTELLIGENT TECHNOLOGY CO., LTD., Jiangsu (CN)

(72) Inventor: Linjie ZANG, Jiangsu (CN)

(21) Appl. No.: 18/712,639

(22) PCT Filed: Dec. 1, 2022
(86) PCT No.: PCT/CN2022/135984

§ 371 Date: May 22, 2024

(30) Foreign Application Priority Data
Mar. 2, 2022 (CN) 202210195258.6

(51) Int. Cl. G06F 16/18; G06F 16/16

(52) U.S. Cl. CPC G06F 16/1815; G06F 16/164; G06F 16/1847

(57) ABSTRACT

A journal storage acceleration method, applied to a distributed storage system and the method comprising: dividing a to-be-written file into a plurality of to-be-written objects, respectively storing the plurality of to-be-written objects in object placement groups, and then constructing corresponding small-block write operations based on the plurality of to-be-written objects and the object placement groups (S11); committing the small-block write operations to a journal file system by using a journal queue, writing the small-block write operations into a hash-based multi-linked list data structure through the journal file system, so as to merge the small-block write operations into a large-block sequential write operation, and flushing of the large-block sequential write operation to a write-back queue (S12); and writing back the large-block sequential write operation in the write-back queue into an extended file system for storage (S13). By virtue of the solution, the small-block write operations are merged into the large-block sequential write operation by using the hash-based multi-linked list data structure, and flushing of the small-block write operations is changed to flushing of the large-block sequential write operation, such that journal storage is accelerated, thereby improving the storage performance.

### CROSS-REFERENCE TO RELATED APPLICATION

The present disclosure claims priority to Chinese Patent Application No. 202210195258.6, filed with the China National Intellectual Property Administration on Mar. 2, 2022 and entitled “Journal Storage Acceleration Method and Apparatus, Device and Medium”, which is incorporated herein by reference in its entirety.

### TECHNICAL FIELD

Embodiments of the present disclosure relate to the technical field of distributed storage, and in particular, to a journal storage acceleration method and apparatus, an electronic device and a non-volatile readable storage medium.

### BACKGROUND

Currently, many file systems, whether local file systems such as Extended file system (EXT) 3/4 or distributed object storage systems, adopt a mechanism of writing a journal first in order to ensure consistency and durability of data when the systems crash or are powered off. According to this mechanism, each write transaction is first committed to an append-write-only journal, and then written back to an extended file system. When the system crashes or is powered off, a recovery process will scan the journal and then re-handle write transactions that have not been successfully completed. In earlier technologies, a journal file system mainly uses a Hard Disk Drive (HDD) as an underlying storage device for journal and data. With the continuous innovation of technologies and continuous development of Non-Volatile Memory-express (NVMe) technologies, NVMe Solid-State Drives (NVMe SSDs) have attracted wide attention from researchers in the academic and industrial fields. The storage performance of the NVMe SSD is faster than that of the HDD by several orders of magnitude. However, as for the demand for Input/Output (IO) storage performance in the current journal file system, the performance still needs to be continuously optimized.

In the related art, many journal file systems use non-volatile memory devices (e.g., the NVMe SSDs) as journal storage devices so as to improve the storage IO performance. However, in the scenarios where massive small files need to be input and/or output, a severe storage IO jitter situation may occur, as writing massive small-file data blocks back to the extended file system (XFS) on a persistent disk drive is much slower than journal writing, and the utilization rate of the NVMe SSD is extremely low. Meanwhile, when there are many small files which are stored and written back to the HDD for persistent storage, that is, when a write-back queue is fully occupied and blocked, a journal queue becomes idle, and performance advantages of the SSDs cannot be exerted.

In conclusion, how to accelerate the journal storage speed and improve the storage IO performance is a problem to be urgently solved at present.

### SUMMARY

In view of this, the embodiments of the present disclosure provide a journal storage acceleration method and apparatus, a device and a medium, which may accelerate the journal storage speed and improve the storage IO performance. Detailed solutions thereof are described as follows.

According to a first aspect of the embodiments of the present disclosure, provided is a journal storage acceleration method, applied to a distributed storage system and including:
a to-be-written file is divided into a plurality of to-be-written objects, the plurality of to-be-written objects are respectively stored in object placement groups, and then corresponding small-block write operations are constructed based on the plurality of to-be-written objects and the object placement groups;
the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue; and
the large-block sequential write operation in the write-back queue is written back into an extended file system for storage.

In some exemplary embodiments, the operation that corresponding small-block write operations are constructed based on the plurality of to-be-written objects and the object placement groups includes:
to-be-written data corresponding to the plurality of to-be-written objects are acquired, object placement group identifiers are set for the object placement groups and object identifiers are set for the plurality of to-be-written objects, and then target operation serial numbers of the small-block write operations are set according to a preset operation sequence; and
the small-block write operations each sequentially containing the object placement group identifier, the object identifier, the target operation serial number, and the to-be-written data are constructed in a form of quadruples.

In some exemplary embodiments, the operations that the small-block write operations are written into the hash-based multi-linked list data structure through the journal file system, so as to merge the small-block write operations to obtain the large-block sequential write operation, and the large-block sequential write operation is flushed to the write-back queue include:
for each small-block write operation in the small-block write operations, a target slot is searched from the hash-based multi-linked list data structure based on an open addressing method through the journal file system and by using the object identifier in each small-block write operation;
when the target slot is not found, the small-block write operation is directly flushed to the write-back queue; when the target slot is found, the small-block write operation is mapped to the target slot, and a target block is searched from a target linked list corresponding to the target slot by using the object placement group identifier in the small-block write operation;
when the target block is not found, the small-block write operation is directly flushed to the write-back queue; and when the target block is found, the small-block write operation is merged into the target block in a manner of append-write data, so as to obtain the large-block sequential write operation, and then the large-block sequential write operation is flushed into the write-back queue.

In some exemplary embodiments, the operation that the large-block sequential write operation in the write-back queue is written back into the extended file system for storage includes:
the large-block sequential write operation in the write-back queue and the small-block write operations directly flushed to the write-back queue are written back to the extended file system, and stored according to a write-back sequence.

In some exemplary embodiments, after the large-block sequential write operation in the write-back queue and the small-block write operations directly flushed to the write-back queue are written back to the extended file system, and stored according to the write-back sequence, the method further includes:
the small-block write operations corresponding to the large-block sequential write operation stored in the extended file system and the small-block write operations directly flushed to the write-back queue are determined as target write operations;
the target operation serial numbers corresponding to the target write operations are determined as serial numbers of operations to be checked, and the serial numbers of the operations to be checked are stored into a preset linked list according to the write-back sequence; and
the serial numbers of the operations to be checked which are stored in the preset linked list are checked according to a serial number of an operation to be written back which is stored in a preset check recording unit, so as to sort the serial numbers of the operations to be checked in the preset linked list according to the preset operation sequence.

In some exemplary embodiments, before the serial numbers of the operations to be checked which are stored in the preset linked list are checked according to a serial number of an operation to be written back which is stored in the preset check recording unit, the method further includes:
according to the preset operation sequence, the target operation serial number corresponding to the first small-block write operation that has not been written back to the extended file system is determined as the serial number of the operation to be written back, and the serial number of the operation to be written back is stored in the preset check recording unit.

In some exemplary embodiments, the operation that the small-block write operations are written into the hash-based multi-linked list data structure through the journal file system includes:
based on a multi-thread write mode, the small-block write operations are written into the hash-based multi-linked list data structure through the journal file system.

According to a second aspect of the embodiments of the present disclosure, provided is a journal storage acceleration apparatus, applied to a distributed storage system and including:
a small-block write operation construction module, configured to divide a to-be-written file into a plurality of to-be-written objects, respectively store the plurality of to-be-written objects in object placement groups, and then construct corresponding small-block write operations based on the plurality of to-be-written objects and the object placement groups;
a small-block write operation merging module, configured to commit the small-block write operations to a journal file system by using a journal queue, write the small-block write operations into a hash-based multi-linked list data structure through the journal file system, so as to merge the small-block write operations into a large-block sequential write operation, and flush the large-block sequential write operation to a write-back queue; and
a large-block sequential write operation storage module, configured to write back the large-block sequential write operation in the write-back queue into an extended file system for storage.

According to a third aspect of the embodiments of the present disclosure, provided is an electronic device, including a processor and a memory; wherein when the processor executes a computer program stored in the memory, the journal storage acceleration method as disclosed above is implemented.

According to a fourth aspect of the embodiments of the present disclosure, provided is a computer non-volatile readable storage medium, configured to store a computer program; wherein when executed by a processor, the computer program implements the journal storage acceleration method as disclosed above.

Hence, in the embodiments of the present disclosure, the to-be-written file is divided into a plurality of to-be-written objects, the plurality of to-be-written objects are respectively stored in object placement groups, and then corresponding small-block write operations are constructed based on the plurality of to-be-written objects and the object placement groups; the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue; and the large-block sequential write operation in the write-back queue is written back into an extended file system for storage. By virtue of the solution, the small-block write operations are merged into the large-block sequential write operation by using the hash-based multi-linked list data structure, and flushing of the small-block write operations is changed to flushing of the large-block sequential write operation, such that journal storage is accelerated, thereby improving the storage IO performance.

### BRIEF DESCRIPTION OF THE DRAWINGS

In order to describe the technical solutions in the embodiments of the present disclosure or in the related art more clearly, hereinafter, accompanying drawings requiring to be used for describing the embodiments or the related art are introduced briefly. Apparently, the accompanying drawings in the following description merely relate to the embodiments of the present disclosure, and for a person having ordinary skill in the art, other accompanying drawings may also be obtained according to the provided accompanying drawings without involving any inventive effort.

FIG. 1 is a flowchart of a journal storage acceleration method provided according to some embodiments of the present disclosure;

FIG. 2 is a schematic diagram of an access architecture of a distributed storage file system in the related art;

FIG. 3 is a schematic diagram of data storage in a distributed storage cluster in the related art;

FIG. 4 is a schematic diagram of a journal storage acceleration method provided according to some embodiments of the present disclosure;

FIG. 5 is a flowchart of an exemplary journal storage acceleration method provided according to some embodiments of the present disclosure;

FIG. 6 is a hash-based multi-linked list data structure provided according to some embodiments of the present disclosure;

FIG. 7 is a schematic diagram of a journal storage acceleration apparatus provided according to some embodiments of the present disclosure; and

FIG. 8 is a structural diagram of an electronic device provided according to some embodiments of the present disclosure.

### DETAILED DESCRIPTION OF THE EMBODIMENTS

Hereinafter, the technical solutions in the embodiments of the present disclosure will be described clearly and thoroughly with reference to the accompanying drawings of the embodiments of the present disclosure. Obviously, the embodiments as described are only some of the embodiments of the present disclosure, and are not all of the embodiments of the present disclosure. All other embodiments obtained by a person having ordinary skill in the art based on the embodiments of the present disclosure without any inventive effort shall all fall within the scope of protection of the present disclosure.

Currently, in the scenarios where massive small files need to be input and/or output, a severe storage IO jitter situation may occur, as writing massive small-file data blocks back to the extended file system (XFS) on a persistent disk drive is much slower than journal writing, and the utilization rate of the NVMe SSD is extremely low. Meanwhile, when there are many small files which are stored and written back to the HDD for persistent storage, that is, when a write-back queue is fully occupied and blocked, a journal queue becomes idle, and performance advantages of the SSDs cannot be exerted. In order to overcome the problems above, the embodiments of the present disclosure provide a journal storage acceleration solution, which may accelerate the journal storage speed and improve the storage IO performance.

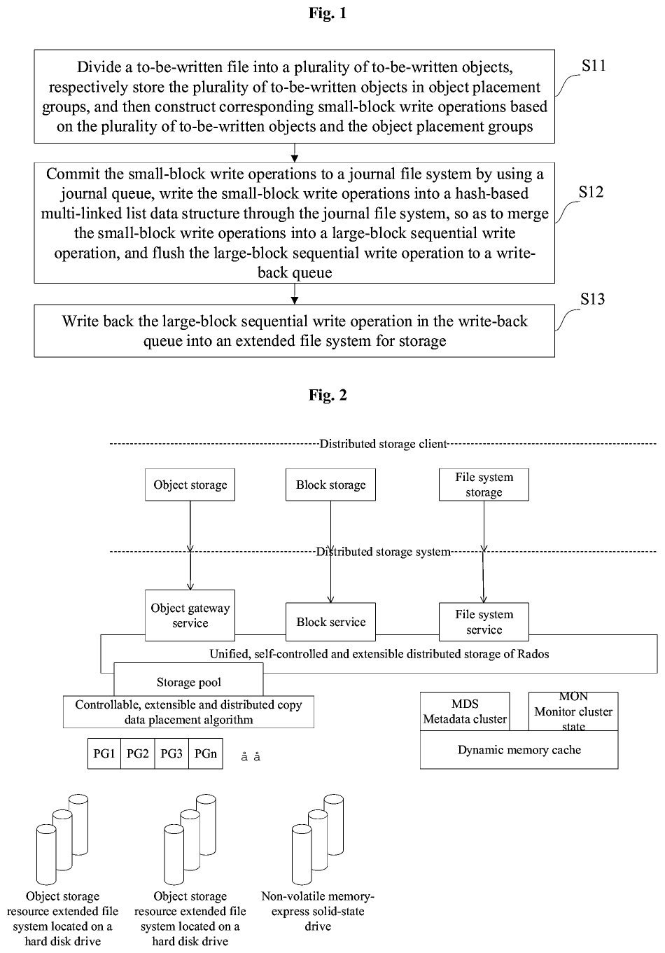

Refer to FIG. 1, the embodiments of the present disclosure provide a journal storage acceleration method, applied to a distributed storage system and including the following operations S11 to S13.

At operation S11, a to-be-written file is divided into a plurality of to-be-written objects, the plurality of to-be-written objects are respectively stored in object placement groups, and then corresponding small-block write operations are constructed based on the plurality of to-be-written objects and the object placement groups.

In the embodiments of the present disclosure, a distributed storage system is used, and a data storage backend Object Storage Device (OSD) process adopts a journal file system mechanism. As shown in FIG. 2, unified, self-controlled and extensible distributed storage is provided, in which three protocol access interfaces, i.e., Object Storage, Block Storage and File System Storage are provided, which may allow for interaction with the backend via an underlying dynamic library. A distributed cluster corresponds to an object gateway (e.g., a Reliable, Autonomic Distributed Object Store (Rados) Gateway (GW) S3 Swift) service, block (Reliable, Autonomic Distributed Object Store block data (RBD, block storage) service and file system (LibFS) service, wherein the Reliable, Autonomic Distributed Object Store (Rados) provides the unified, self-controlled and extensible distributed storage. DRAM Cache is a dynamic memory cache, DRAM is a dynamic random access memory, and cache is a cache. In the file system, an MDS metadata cluster (or referred to as a metadata service cluster) and a monitor service (MON) cluster are also necessary to monitor a process and maintain a cluster state. The data is stored in a storage pool, and is mapped, by means of Placement Groups (PGs), to the backend for storage. In order to better allocate and position data, an object storage unit is included, and is used for the function of storing data. In addition, HDD OSD represents an OSD extended file system located on HDD, and HDD SSD is a solid-state hard disk drive. In the embodiments of the present disclosure, it is particularly pointed out that in a distributed file system, each file is divided into objects in several directories, wherein the directories also identify object placement groups. When one write operation is performed, the write operation is first written to one interface (e.g., a Rados file system interface) which converts file write into object write. In the operation S11, a to-be-written file is divided into a plurality of to-be-written objects, the plurality of to-be-written objects are respectively stored in object placement groups, and then corresponding small-block write operations are constructed based on the plurality of to-be-written objects and the object placement groups.

It is to be noted that FileStore represents a file system and storage of journal backups. In the distributed storage system, FileStore is usually used as a backend storage engine of the distributed storage system, and the FileStore uses a Portable Operating System Interface (POSIX interface) of the file system to implement an Object Store Application Programming Interface (API). Each Object is considered as one file at the FileStore layer, and an Object attribute (xattr) is accessed by using an xattr attribute of the file. As some file systems (such as Ext4) have a limit on the length of the xattr, Metadata exceeding the length is stored in a database object mapping table structure (DBObjectMap), wherein the DBObjectMap is a part of the FileStore, and encapsulates a series of APIs for operations on a KeyValue (key words and values stored in a database) database. In addition, a Key Value (i.e., key value pair, short as KV) relationship of the Object is directly implemented by using the DBObjectMap. However, the FileStore has some problems, for example, the Journal mechanism changes one write request to two write operations (synchronously writing Journal and asynchronously writing Object) at an OSD end of the distributed storage system (in response to a process that a client requests to return detailed data); and the SSD is used as a Journal to decouple mutual effects of the Journal and Object write operations. Each written Object corresponds to one physical file of an OSD local file system on a one-to-one basis. For a large number of small-Object storage scenarios, the OSD end cannot cache metadata of all local files, so that read and write operations may require multiple times of local IOs, resulting in performance degradation of the storage system.

At operation S12, the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue.

In the embodiments of the present disclosure, according to a condition that the performance of an HDD when performing a large-block sequential write operation is better than that of a random small-block write operation, a new memory acceleration journal merging architecture is designed, and a Hash-based multi-linked list data structure is introduced into the memory to realize journal merging.

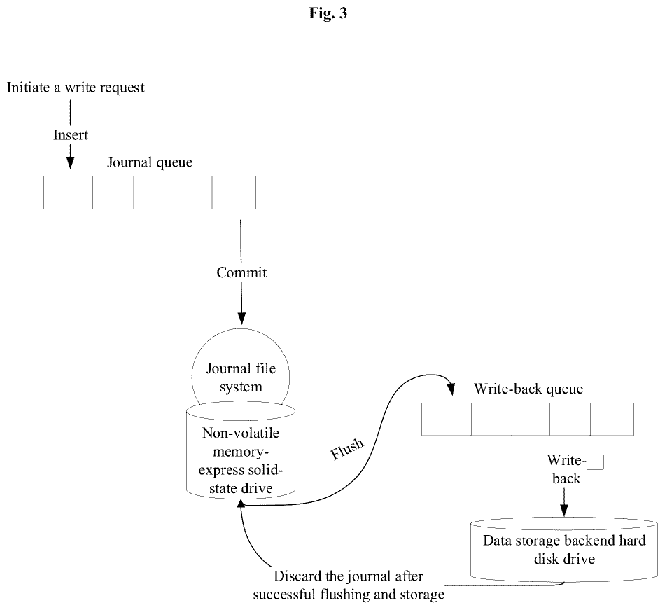

It should be noted that, in the related art, as shown in FIG. 3, when a write request is initiated, an NVMe SSD is used as a storage medium of a journal file system, and each write transaction is first committed to the journal file system via a journal queue, wherein a commitment (or submitting) manner is Commit, and then write operations are flushed in batches to a write-back queue. The flushing is performed by using a fsync function. The fsync function is used to synchronize all modified file data in the memory to a storage device.

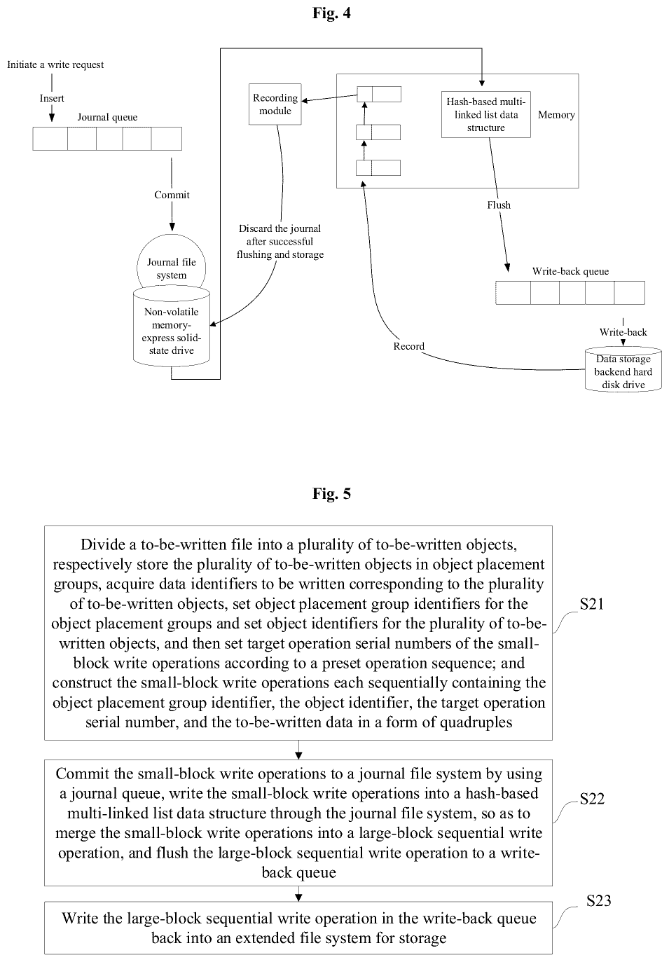

In the embodiments of the present disclosure, the write process of a journal merging mechanism is different from the write process in the conventional art. As shown in FIG. 4, the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue. It should be noted that the journal file system is located in the NVMe SSD. The operation of flushing data from the journal to an HDD disk mainly includes two stages. A first stage is to write each random small-block write operation into the Hash-based multi-linked list data structure; and a second stage is to flush the plurality of merged random small-block write operations to the write-back queue, that is, the large-block sequential write operation is also flushed to the write-back queue. It may be understood that the embodiments of the present disclosure fully utilize a high-speed storage medium, i.e., NVMe SSD, in which the IO performance of the journal file system is accelerated by using a journal memory merging mechanism, thereby improving the IO performance of distributed data storage. Compared with the related art, the embodiments of the present disclosure not only optimize a first commitment stage of the journal mechanism, but also optimize a second stage of writing back for backend persistent storage, thereby effectively reducing the technical problems of jitter and instability of persistent storage performance of distributed storage of backend data.

At operation S13, the large-block sequential write operation in the write-back queue is written back into an extended file system for storage.

In the embodiments of the present disclosure, as shown in FIG. 3, after the write operations are flushed in batches to the write-back queue, the write operations are written back to an OSD extended file system on the HDD. If the write-back is successful, the data becomes permanent, and after the data is flushed and stored successfully, related journal items are discarded from the journal based on check bits. If the system crashes or is powered off, a redo journal and journal check bit mechanism may be used to recover hard disk data to the latest consistency state. In order to reduce the burden of performing journal recording for all the data, most file systems only perform journal recording on metadata, and as the metadata cannot ensure the persistence of all the data, the metadata is only applicable to specific application programs. In addition, the speed of writing random small-block files into a Journal based on the NVMe SSD is relatively fast; however, the speed of writing random small-blocks is relatively slow when flushing the journal to a backend data persistent storage disk based on HDD. Therefore, a situation in which the write-back queue is fully occupied and blocked may occur, which may cause a queue of the journal file system to be in a blocked sleep state, thereby causing a serious performance fluctuation; however, for a large number of random writes of large-block files, HDD has relatively good performance, and in this case, the write-back speed is high. Since the cost of replacing all HDDs with SSDs is relatively high, which is not of practical significance at present, the embodiments of the present disclosure propose a method for applying journal records to the whole data, and realize a journal memory merging acceleration mechanism by means of the Hash-based multi-linked list data structure.

It should be noted that, in the embodiments of the present disclosure, a recording module is designed and the function of the recording module is to record write operations that have been successfully written into an extended file system of the HDD, and by recording, merged data may be flushed to the HDD for management, thereby improving the durability and stability of the data.

It needs to be pointed out that, by adopting the Hash-based multi-linked list data structure, grouped merging on written small files is performed according to the characteristics of multi-thread write, thereby realizing the journal memory merging acceleration mechanism; and the Hash-based multi-linked list data structure may effectively aggregate small-block files, and may also improve the data flushing performance. In addition, the embodiments of the present disclosure improve the metadata index performance of a write request; when an object is opened and closed, the data fsync flushing performance is improved, and also, the number of times of writing addressing and opening and closing the object is reduced, thereby increasing the write-back efficiency. A new data flushing solution is designed to make full use of the performance advantages of journal merging, and also prevent the problem that the journal queue is too long. In addition, in the embodiments of the present disclosure, a security check mechanism is designed to ensure the data persistence of the journal.

Hence, in the embodiments of the present disclosure, the to-be-written file is divided into a plurality of to-be-written objects, the plurality of to-be-written objects are respectively stored in object placement groups, and then corresponding small-block write operations are constructed based on the plurality of to-be-written objects and the object placement groups; the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue; and the large-block sequential write operation in the write-back queue is written back into an extended file system for storage. By virtue of the solution, the small-block write operations are merged into the large-block sequential write operation by using the hash-based multi-linked list data structure, and flushing of the small-block write operations is changed to flushing of the large-block sequential write operation, such that journal storage is accelerated, thereby improving the storage IO performance.

Refer to FIG. 5, the embodiments of the present disclosure provide an exemplary journal storage acceleration method, applied to a distributed storage system and including the following operations S21 to S23.

At operation S21, a to-be-written file is divided into a plurality of to-be-written objects, the plurality of to-be-written objects are respectively stored in object placement groups, to-be-written data (and/or to-be-written data identifiers) corresponding to the plurality of to-be-written objects are acquired, object placement group identifiers are set for the object placement groups and object identifiers are set for the plurality of to-be-written objects, and then target operation serial numbers of the small-block write operations are set according to a preset operation sequence; and the small-block write operations each sequentially containing the object placement group identifier, the object identifier, the target operation serial number, and the to-be-written data are constructed in a form of quadruples.

In the embodiments of the present disclosure, the to-be-written file is divided into a plurality of to-be-written objects, the plurality of to-be-written objects are respectively stored in object placement groups, to-be-written data corresponding to the plurality of to-be-written objects are acquired, object placement group identifiers are set for the object placement groups and object identifiers are set for the plurality of to-be-written objects, and then target operation serial numbers of the small-block write operations are set according to a preset operation sequence; wherein the object placement group identifiers may be represented by cid, the to-be-written data identifiers may be represented by oid, the target operation serial numbers may be represented by sn, and the to-be-written data may be represented by data; and then the small-block write operations each sequentially containing the object placement group identifier, the object identifier, the target operation serial number, and the to-be-written data are constructed in a form of quadruples.

Therefore, each of the small-block write operations may be represented as a quadruple [cid, oid, sn, data]. It should be noted that, when the number of objects in an object placement group is generally small, the number of object groups may be very large; and therefore, the time required for positioning one object is short. In other words, cid may vary within a very large range, while the number of oids is limited.

At operation S22, the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue.

In the embodiments of the present disclosure, the hash-based multi-linked list data structure is initialized in a memory, and includes a combination of N slots and N linked lists, wherein each slot serves as a start pointer of the linked list.

It should be noted that, in the embodiments of the present disclosure, based on a multi-thread write mode, the small-block write operations are written into the hash-based multi-linked list data structure through the journal file system, thereby accelerating the speed.

It should be noted that, in the hash table, a Hash conflict is solved by using the to-be-written data identifier as a Key and adopting an open addressing method, wherein the hash conflict refers to a case that a same hash address may be obtained corresponding to different keys, that is, a case in which key1≠key2, but f(key1)=f(key2). In the open addressing method, all elements are stored in the hash table, and when a hash conflict occurs, a next candidate position is calculated by a probe function; and if the next selected position is still conflicting, then continuous searching is performed by the probe function, until an empty slot is found to store an element to be inserted. An open address means that except that an address obtained by a hash function is available, other addresses are also available when a conflict occurs, and common methods of the open address idea are linear probing and re-hashing, secondary probing and re-hashing, etc., and these methods are all solutions in cases where the position of the first selection is occupied. By this method, when there are empty slots in the hash table, the values of different oids are mapped to different slots. As shown in the Hash-based multi-linked list data structure of FIG. 6, each linked list contains M blocks, the size of each block is equal to the size of an object designated by the file system; blocks located at the same position in the linked list are associated with the same cid, and the values of the cids corresponding to the blocks are allocated to the most frequently used blocks, and update is performed after triggering the whole flushing operation. Obviously, the memory consumption of the Hash-based multi-linked list data structure is determined by the parameters M and N and the size of the object. Therefore, appropriate values of the parameters M and N are selected, and memory occupation is controllable.

In the embodiments of the present disclosure, the process that the small-block write operations are written into the hash-based multi-linked list data structure through the journal file system, so as to merge the small-block write operations to obtain the large-block sequential write operation, and the large-block sequential write operation is flushed to the write-back queue is: for each small-block write operation in the small-block write operations, a target slot is searched from the hash-based multi-linked list data structure based on an open addressing method through the journal file system and by using the object identifier in each small-block write operation; when the target slot is not found, the small-block write operation is directly flushed to the write-back queue; when the target slot is found, the small-block write operation is mapped to the target slot, and a target block is searched from a target linked list corresponding to the target slot by using the object placement group identifier in the small-block write operation; when the target block is not found, the small-block write operation is directly flushed to the write-back queue; and when the target block is found, the small-block write operation is merged into the target block in a manner of append-write data, so as to obtain the large-block sequential write operation, and then the large-block sequential write operation is flushed into the write-back queue. It is assumed that one write operation [cid, oid, sn, data] is input into the Hash-based multi-linked list data structure in a first stage of the flushing. According to oid, a write thread will attempt to map the write operation to a certain slot N in the hash table. If the mapping is not successful (i.e., there is no empty slot in the hash table and oid thereof is different from the existing slot), the operation will immediately be flushed to the write-back queue. If the mapping is successful, the write thread will check whether there is a block associated with the cid in corresponding linked list. If there is no such block, the write operation will directly be flushed to the write-back queue; otherwise, the block will be merged into M blocks in a way of append-write data. By the method, small-file random small-block writes are merged into large-file sequential write, and the embodiments of the present disclosure improve the metadata index performance of a write-back request. Moreover, the data is merged into a large file, the number of file objects is reduced, and thus when an object is opened and closed, the data sync flushing performance is improved, and also, the number of times of writing addressing and opening and closing the object is reduced, thereby increasing the write-back efficiency. As shown in FIG. 6, there are four small-block write operations, which are [cid1, oid1, sn8, 8 KB], [cid1, oid1, sn7, 8 KB], [cid2, oid7, sn4, 4 KB] and [cid1, oid1, sn1, 4 KB], respectively. Target slots in the hash table are found for the four write operations according to the oids, and the four write operations are mapped to the target slots, then target blocks are searched according to the cids, and the small-block write operations are merged into the target blocks in a manner of append-write data.

It should be noted that, the write operations of flushing to the write-back queue include the large-block sequential write operation and the small-block write operations, and then the large-block sequential write operation in the write-back queue and the small-block write operations directly flushed to the write-back queue need to be written back to the extended file system, and are stored according to the write-back sequence.

It may be understood that in the embodiments of the present disclosure, in the journal file system, the write operations may be added to the journal file. There is a check recording unit in the journal file, i.e., the recording module in FIG. 4, hereinafter referred to as a check point, wherein the check point is regularly updated, and the first write operation which has not been written back to the file system at the last check point is recorded. In a conventional journal file system, the sequence in which write operations are written back to the file system is the same as the sequence in which they are appended to the journal file. Therefore, the check point only needs to record the sn of the write operation successfully written back to the file system last time. However, in the embodiments of the present disclosure, in the memory merging journal mechanism, due to the merging operation, the write operations in the journal file may be disordered. Therefore, the serial number of the write operation successfully written back to the file system last time is insufficient for the check. Therefore, in the embodiments of the present disclosure, the sns of all write operations successfully written back since the last check point are recorded. In some exemplary embodiments, a linked list is used to record the sns, and for each new write operation which has been successfully written back, the sn of the new write operation is inserted into a preset linked list, so that all the sns in the preset linked list are sorted according to the sequence of these write operations in a journal. In some exemplary embodiments, the small-block write operations corresponding to the large-block sequential write operation stored in the extended file system and the small-block write operations directly flushed to the write-back queue are determined as the target write operations; the target operation serial numbers corresponding to the target write operations are determined as serial numbers of operations to be checked, and the serial numbers of the operations to be checked are stored into a preset linked list according to the write-back sequence; and the serial numbers of the operations to be checked which are stored in the preset linked list are checked according to a serial number of an operation to be written back which is stored in a preset check recording unit, so as to sort the serial numbers of the operations to be checked in the preset linked list according to the preset operation sequence. In the sorting process, the process of the check point is performed as follows. The sn value of a write operation at the check point is compared with the sn value of a first node in the preset linked list. If they are equal, then the check point is moved backward through one write operation and the first node in the preset linked list is deleted, and this operation is then repeated; otherwise, the process ends. Based on this new check point mechanism, data persistence is ensured in a fault scenario recovery process. It should be noted that, the preset linked list is located in the memory in FIG. 4.

It should be noted that, the check point only needs to record the sns of write operations successfully written back to the file system last time, i.e., the target operation serial numbers. Therefore, according to the preset operation sequence, the target operation serial number corresponding to the first small-block write operation that has not been written back to the extended file system is determined as the serial number of the operation to be written back, and the serial number of the operation to be written back is stored in the preset check recording unit.

At operation S23, the large-block sequential write operation in the write-back queue is written back into an extended file system for storage.

In the embodiments of the present disclosure, an NVMe SSD is used as a storage medium of the journal file system, thereby solving the problem of performance jitter caused by random large writes of small files in distributed storage. The embodiments of the present disclosure propose a memory merging journal mechanism, a memory acceleration architecture, and controllable memory occupation. The memory merging journal mechanism introduces a data structure into the memory to merge random small-file writes, and also prevents the journal and the recording unit journal from growing and occupying resources. The embodiments of the present disclosure adopt a new recording journal, i.e., a check point process, to maintain data persistence. Compared with the related art, the embodiments of the present disclosure may achieve stable performance and data reliability in terms of IOPS (Input/Output Operations Per Second, the number of times of read and write operations per second) and write latency during random large writes of small files.

It needs to be pointed out that the embodiments of the present disclosure have the following advantages. In terms of performance, i.e., the performance IOPS of massive small files of the distributed storage system, compared with a conventional journal file system, the overall IO performance is significantly improved. In terms of stability, as data is stored over time, the IO performance is relatively stable. In terms of durability, once successfully committed to a journal, a write transaction will be stored persistently, which means that the solution has high durability. In terms of cost, the additional resource consumption generated in the embodiments of the present disclosure is maintained at a low level, and therefore the solution has low cost. In terms of compatibility, the technology in the embodiments of the present disclosure may be integrated into the existing journal file system, and therefore has good compatibility.

Hence, in the embodiments of the present disclosure, the to-be-written file is divided into a plurality of to-be-written objects, the plurality of to-be-written objects are respectively stored in object placement groups, and then corresponding small-block write operations are constructed based on the plurality of to-be-written objects and the object placement groups; the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue; and the large-block sequential write operation in the write-back queue is written back into an extended file system for storage. By virtue of the solution, the small-block write operations are merged into the large-block sequential write operation by using the hash-based multi-linked list data structure, and flushing of the small-block write operations is changed to flushing of the large-block sequential write operation, such that journal storage is accelerated, thereby improving the storage performance.

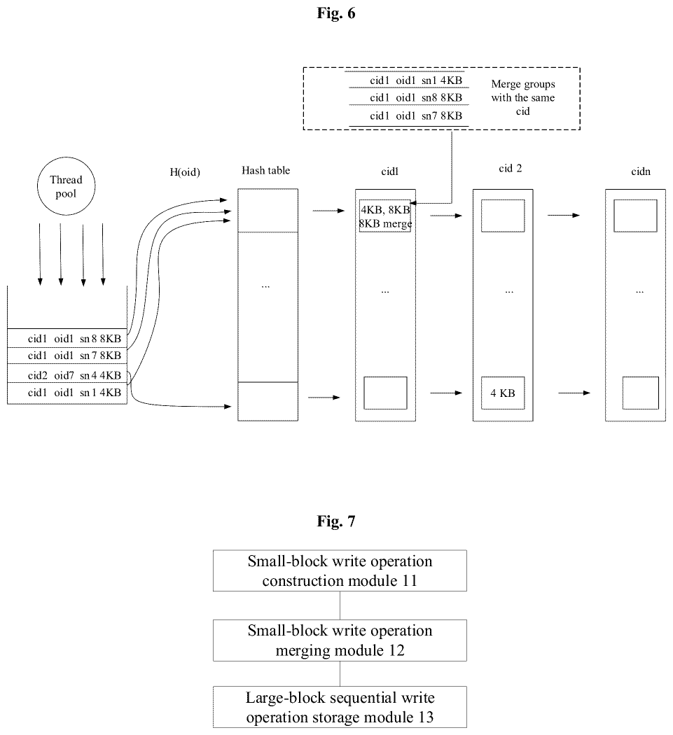

Refer to FIG. 7, the embodiments of the present disclosure provide a journal storage acceleration apparatus, including:
a small-block write operation construction module 11, configured to divide a to-be-written file into a plurality of to-be-written objects, respectively store the plurality of to-be-written objects in object placement groups, and then construct corresponding small-block write operations based on the plurality of to-be-written objects and the object placement groups;
a small-block write operation merging module 12, configured to commit the small-block write operations to a journal file system by using a journal queue, write the small-block write operations into a hash-based multi-linked list data structure through the journal file system, so as to merge the small-block write operations into a large-block sequential write operation, and flush the large-block sequential write operation to a write-back queue; and
a large-block sequential write operation storage module 13, configured to write back the large-block sequential write operation in the write-back queue into an extended file system for storage.

For a more detailed working process of each module, reference may be made to the corresponding content disclosed in the embodiments above, and details will not be repeated herein.

Hence, in the embodiments of the present disclosure, the to-be-written file is divided into a plurality of to-be-written objects, the plurality of to-be-written objects are respectively stored in object placement groups, and then corresponding small-block write operations are constructed based on the plurality of to-be-written objects and the object placement groups; the small-block write operations are committed to a journal file system by using a journal queue, and the small-block write operations are written into a hash-based multi-linked list data structure through the journal file system, so as to merge the small-block write operations into a large-block sequential write operation, and the large-block sequential write operation is flushed to a write-back queue; and the large-block sequential write operation in the write-back queue is written back into an extended file system for storage. By virtue of the solution, the small-block write operations are merged into the large-block sequential write operation by using the hash-based multi-linked list data structure, and flushing of the small-block write operations is changed to flushing of the large-block sequential write operation, such that journal storage is accelerated, thereby improving the storage performance.

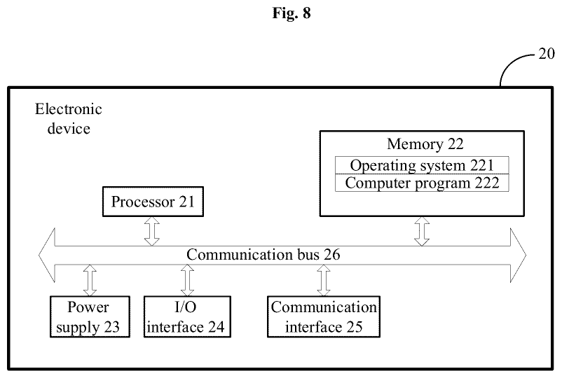

In some exemplary embodiments, the embodiments of the present disclosure further provide an electronic device. FIG. 8 is a structural diagram of an electronic device 20 according to exemplary embodiments. The content in the figure cannot be considered as any limitation to the use range of the embodiments of the present disclosure.

FIG. 8 is a schematic structural diagram of an electronic device 20 provided according to some embodiments of the present disclosure. The electronic device 20 includes: at least one processor 21, at least one memory 22, a power supply 23, an input/output interface 24, a communication interface 25 and a communication bus 26. The memory 22 is used to store a computer program, and the computer program is loaded and executed by the processor 21, so as to implement relevant operations in the journal storage acceleration method disclosed any one of the embodiments above.

In this embodiment, the power supply 23 is configured to provide an operating voltage for each hardware device on the electronic device 20; the communication interface 25 may establish a data transmission channel with an external device for the electronic device 20, and the communication interface 25 may follow any communication protocol that may be applied to the technical solutions in embodiments of the present disclosure, which will not be limited herein; and the input/output interface 24 is configured to acquire external input data or output data to the outside, and the detailed interface type of the input/output interface may be selected according to actual application requirements, which will not be limited herein.

In addition, the memory 22, as a carrier for resource storage, may be a read-only memory, a random access memory, a magnetic disk or an optical disk, etc. The memory 22, as a non-volatile memory that may include a random access memory as a running memory and a storage purpose set as an external memory, storage resources thereon include an operating system 221, a computer program 222, and the like, and the storage manner may be temporary storage or permanent storage.

The operating system 221 is used to manage and control each hardware device on the electronic device 20 on a source host and the computer program 222; and the operating system 221 may be Microsoft Windows operating system (Windows), Unix, Linux (GNU/Linux), and the like. In addition to the computer program that may be used for implementing the journal storage acceleration method executed by the electronic device 20 disclosed in any one of the embodiments above, the computer program 222 may further include a computer program that may be used for performing other specific operations.

In this embodiment, the input/output interface 24 may include, but is not limited to, a Universal Serial Bus (USB) interface, a hard disk read interface, a serial interface, a voice input interface, a fingerprint input interface, and the like.

In some exemplary embodiments, the embodiments of the present disclosure further disclose a computer non-volatile readable storage medium, configured to store a computer program; wherein when executed by a processor, the computer program implements the journal storage acceleration method as disclosed above.

For operations of the method, reference may be made to the corresponding content disclosed in the embodiments above, and details will not be repeated herein.

The computer non-volatile readable storage medium includes a Random Access Memory (RAM), a memory, a Read-Only Memory (ROM), an electrically programmable ROM, an electrically erasable programmable ROM, a register, a hard disk, a magnetic disk, an optical disk, or any other form of storage medium known in the art. When executed by a processor, the computer program implements the journal storage acceleration method. For operations of the method, reference may be made to the corresponding content disclosed in the embodiments above, and details will not be repeated herein.

The embodiments in the present description are described in a progressive manner. Each embodiment focuses on differences from other embodiments. For the same or similar parts among the embodiments, reference may be made to each other. For the apparatus disclosed in the embodiments, as the apparatus corresponds to the journal storage acceleration method disclosed in the embodiments, the illustration thereof is relatively simple, and for the related parts, reference may be made to the illustration of the method part.

A person having ordinary skill in the art may further appreciate that units and algorithm operations in examples described in combination with the embodiments disclosed herein may be achieved in the form of electronic hardware, computer software, or a combination of the two. To clearly describe the interchangeability between the hardware and the software, the illustration above has generally described compositions and operations of each example according to functions. Whether these functions are executed by hardware or software depends on specific applications and design constraint conditions of the technical solutions. A person having ordinary skill in the art could use different methods to implement the described functions for each particular application, but the implementation shall not be considered to go beyond the scope of the embodiments of the present disclosure.

The operations describing algorithms in conjunction with the embodiments disclosed herein may also be directly implemented by hardware, by a software module executed by a processor, or by a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM (compact disc read-only memory), or any other form of storage medium known in the technical field.

Finally, it should be noted that in the present text, relational terms such as first and second, etc. are only used to distinguish one entity or operation from another entity or operation, and do not necessarily require or imply any actual relationship or sequence between these entities or operations. Furthermore, the terms “include”, “including”, or any other variations thereof are intended to cover a non-exclusive inclusion, so that a process, a method, an article, or a device that includes a series of elements not only includes those elements, but also includes other elements that are not explicitly listed, or further includes inherent elements of the process, the method, the article, or the device. Without further limitation, an element defined by a sentence “including a . . . ” does not exclude other same elements existing in a process, a method, an article, or a device that includes the element.

Hereinabove, a journal storage acceleration method and apparatus, a device and a medium provided in the embodiments of the present disclosure are introduced in detail. The principle and embodiments of the present disclosure are described herein by applying optional examples, and the illustration of the embodiments above is only used to help understand the method and core ideas of embodiments of the present disclosure; meanwhile, a person having ordinary skill in the art may make modifications to the actual embodiments and application ranges according to the idea of embodiments of the present disclosure. In conclusion, the content of the description shall not be construed as limitation to the embodiments of the present disclosure.

1. A journal storage acceleration method, applied to a distributed storage system and comprising:
dividing a to-be-written file into a plurality of to-be-written objects, respectively storing the plurality of to-be-written objects in object placement groups, and then constructing corresponding small-block write operations based on the plurality of to-be-written objects and the object placement groups;
committing the small-block write operations to a journal file system by using a journal queue, writing the small-block write operations into a hash-based multi-linked list data structure through the journal file system, so as to merge the small-block write operations into a large-block sequential write operation, and flushing of the large-block sequential write operation to a write-back queue; and
writing back the large-block sequential write operation in the write-back queue into an extended file system for storage.

2. The journal storage acceleration method according to claim 1, wherein constructing corresponding small-block write operations based on the plurality of to-be-written objects and the object placement groups comprises:
acquiring to-be-written data corresponding to the plurality of to-be-written objects, setting object placement group identifiers for the object placement groups and setting object identifiers for the plurality of to-be-written objects, and then setting target operation serial numbers of the small-block write operations according to a preset operation sequence; and
constructing the small-block write operations each sequentially containing the object placement group identifier, the object identifier, the target operation serial number, and the to-be-written data in a form of quadruples.

3. The journal storage acceleration method according to claim 2, wherein writing the small-block write operations into the hash-based multi-linked list data structure through the journal file system, so as to merge the small-block write operations to obtain the large-block sequential write operation, and flushing of the large-block sequential write operation to the write-back queue comprises:
for each small-block write operation in the small-block write operations, searching, based on an open addressing method, for a target slot from the hash-based multi-linked list data structure through the journal file system and by using the object identifier in the small-block write operation;
when the target slot is not found, directly flushing the small-block write operation to the write-back queue; when the target slot is found, mapping the small-block write operation to the target slot, and searching for a target block from a target linked list corresponding to the target slot by using the object placement group identifier in the small-block write operation;
when the target block is not found, directly flushing the small-block write operation to the write-back queue; and when the target block is found, merging the small-block write operation into the target block in a manner of append-write data, so as to obtain the large-block sequential write operation, and then flushing of the large-block sequential write operation into the write-back queue.

4. The journal storage acceleration method according to claim 3, wherein writing back the large-block sequential write operation in the write-back queue into an extended file system for storage comprises:
writing the large-block sequential write operation in the write-back queue and the small-block write operations directly flushed to the write-back queue back to the extended file system, and storing the large-block sequential write operation in the write-back queue and the small-block write operations directly flushed to the write-back queue according to a write-back sequence.

5. The journal storage acceleration method according to claim 4, wherein after writing the large-block sequential write operation in the write-back queue and the small-block write operations directly flushed to the write-back queue back to the extended file system, and storing the large-block sequential write operation in the write-back queue and the small-block write operations directly flushed to the write-back queue according to a write-back sequence, the method further comprises:
determining the small-block write operations corresponding to the large-block sequential write operation stored in the extended file system and the small-block write operations directly flushed to the write-back queue as target write operations;
determining the target operation serial numbers corresponding to the target write operations as serial numbers of operations to be checked, and storing the serial numbers of the operations to be checked into a preset linked list according to the write-back sequence; and
checking the serial numbers of the operations to be checked which are stored in the preset linked list according to a serial number of an operation to be written back which is stored in a preset check recording unit, so as to sort the serial numbers of the operations to be checked in the preset linked list according to the preset operation sequence.

6. The journal storage acceleration method according to claim 5, wherein before checking the serial numbers of the operations to be checked which are stored in the preset linked list according to a serial number of an operation to be written back which is stored in the preset check recording unit, the method further comprises:
according to the preset operation sequence, determining the target operation serial number corresponding to a first small-block write operation that has not been written back to the extended file system as the serial number of the operation to be written back, and storing the serial number of the operation to be written back in the preset check recording unit.

7. The journal storage acceleration method according to claim 1, wherein writing the small-block write operations into the hash-based multi-linked list data structure through the journal file system comprises:
writing, based on a multi-thread write mode, the small-block write operations into the hash-based multi-linked list data structure through the journal file system.

8. The journal storage acceleration method according to claim 1, wherein before dividing the to-be-written file into the plurality of to-be-written objects, the method further comprises:
when a file write operation is detected, writing the to-be-written file into a file system interface, and converting the file write operation into an object write operation through the file system interface, wherein the file write operation is used for requesting to write the to-be-written file.

9. The journal storage acceleration method according to claim 1, wherein the journal file system is located in a Non-Volatile Memory express Solid-State Drive (NVMe SSD).

10. The journal storage acceleration method according to claim 2, wherein
each linked list in the hash-based multi-linked list data structure contains M blocks, wherein a size of each block is equal to a size of an object designated by the journal file system, and a block located at a same position in the linked list is associated with a same object placement group identifier, where M is a positive integer greater than or equal to 2.

11. The journal storage acceleration method according to claim 10, wherein values of the object placement group identifiers corresponding to the blocks are allocated to most frequently used blocks, and update is performed after triggering the whole flushing operation.

12. The journal storage acceleration method according to claim 10, wherein the hash-based multi-linked list data structure is initialized in a memory, and comprises a combination of N slots and N linked lists, wherein each slot serves as a start pointer of the linked list, N is a positive integer greater than or equal to 2, and N and M are values determined according to preset memory consumption of the hash-based multi-linked list data structure.

13. The journal storage acceleration method according to claim 5, wherein the method further comprises:
when the large-block sequential write operation in the write-back queue and the small-block write operations directly flushed to the write-back queue are all successfully written back to the extended file system, discarding the to-be-written file; or
after sorting the serial numbers of the operations to be checked in the preset linked list according to the preset operation sequence, when the operation serial numbers of the small-block write operations corresponding to the large-block sequential write operation in the write-back queue, and the operation serial numbers of the small-block write operations directly flushed to the write-back queue are recorded in the preset linked list, discarding the to-be-written file.

14. The journal storage acceleration method according to claim 5, wherein sorting the serial numbers of the operations to be checked in the preset linked list according to the preset operation sequence comprises:
comparing the serial number of the operation to be written back of the target write operation in the preset check recording unit with a serial number of an operation to be checked in a first node in the preset linked list;
when the serial number of the operation to be written back of the target write operation in the preset check recording unit is equal to the serial number of the operation to be checked in the first node in the preset linked list, moving the preset check recording point backward through one write operation, and deleting the first node in the preset linked list; and
when the serial number of the operation to be written back of the target write operation in the preset check recording unit is not equal to the serial number of the operation to be checked in the first node in the preset linked list, ending the sorting of the serial numbers of the operations to be checked in the preset linked list.

15. The journal storage acceleration method according to claim 5, wherein storing the serial numbers of the operations to be checked into the preset linked list according to the write-back sequence comprises:
inserting the target operation serial number corresponding to each new target write operation which has been successfully written back into the preset linked list as the serial number of the operation to be checked, wherein all the serial numbers of the operations to be checked in the preset linked list are sorted according to the write-back sequence of the target write operation in the journal file system.

16. The journal storage acceleration method according to claim 5, wherein
the preset check recording unit records the target operation serial numbers corresponding to the target write operations in the journal file system which have been successfully written back last time.

17. (canceled)

18. (canceled)

19. An electronic device, comprising a processor and a memory, wherein the processor implements the following operations when executing a computer program stored in the memory:
dividing a to-be-written file into a plurality of to-be-written objects, respectively storing the plurality of to-be-written objects in object placement groups, and then constructing corresponding small-block write operations based on the plurality of to-be-written objects and the object placement groups;
committing the small-block write operations to a journal file system by using a journal queue, writing the small-block write operations into a hash-based multi-linked list data structure through the journal file system, so as to merge the small-block write operations into a large-block sequential write operation, and flushing of the large-block sequential write operation to a write-back queue; and
writing back the large-block sequential write operation in the write-back queue into an extended file system for storage.

20. A computer non-volatile readable storage medium, configured to store a computer program, wherein the computer program, when executed by a processor, implements the following operations:
dividing a to-be-written file into a plurality of to-be-written objects, respectively storing the plurality of to-be-written objects in object placement groups, and then constructing corresponding small-block write operations based on the plurality of to-be-written objects and the object placement groups;
committing the small-block write operations to a journal file system by using a journal queue, writing the small-block write operations into a hash-based multi-linked list data structure through the journal file system, so as to merge the small-block write operations into a large-block sequential write operation, and flushing of the large-block sequential write operation to a write-back queue; and
writing back the large-block sequential write operation in the write-back queue into an extended file system for storage.

21. The journal storage acceleration method according to claim 1, further comprising:
acquiring to-be-written data identifiers corresponding to the plurality of to-be-written objects; and
solving a Hash conflict in the hash-based multi-linked list data structure by using the to-be-written data identifier as a Key and adopting an open addressing method, wherein the hash conflict refers to a case that a same hash address is able to be obtained corresponding to different keys.

22. The journal storage acceleration method according to claim 21, wherein in the open addressing method, all elements are stored in a hash table, and when a hash conflict occurs, a next candidate position is calculated by a probe function, and when the next selected position is still conflicting, then continuous searching is performed by the probe function, until an empty slot is found to store an element to be inserted.
